(19) United States
(12) Patent Application Publication
(10) Pub. No.: US 2019/0228296 A1
(43) Pub. Date: Jul. 25, 2019

(54) SIGNIFICANT EVENTS IDENTIFIER FOR OUTLIER ROOT CAUSE INVESTIGATION

(71) Applicant: EMC IP Holding Company LLC, Hopkinton, MA (US)

(72) Inventors: Avitan Gefen, Tel Aviv (IL); Amihai Savir, Sansana (IL); Ran Taig, Beer Sheva (IL)

(21) Appl. No.: 15/876,025

(22) Filed: Jan. 19, 2018

(51) Int. Cl. G06N 3/08; G06N 3/04; G06N 7/00

(52) U.S. Cl. CPC G06N 3/08; G06N 7/005; G06N 3/0445

(57) ABSTRACT

Embodiments for identifying significant events for finding a root cause of an anomaly collecting time series data for events for each network device by detecting an anomaly in the time series data comprising an outlier on an edge of the time series data by comparing a predicted value of the event to an actual value of the event using a selected forecasting model; declaring the event to be an anomaly at a particular time if a difference between the predicted value and actual value exceed a defined threshold based on residual values for other devices; analyzing in a combined RNN/LSTM process all events for all devices of the network within a time proximity of the particular time of the anomaly to filter usual events and rank each event relative to the anomaly; and displaying a labeled chart of the time series data showing the anomaly in a graph relative to all the events.

### TECHNICAL FIELD

Embodiments are generally directed to computer network monitoring, and more specifically to identifying significant events for anomaly detection and analysis.

### BACKGROUND

Complex systems such as information technology (IT) networks and environments are composed of numerous machines and processes (assets) that are connected in various different ways to source and sink data for each other. It is inevitable that unusual behavior, such as fault conditions, performance anomalies, outages, network breaches/attacks, and so on occur during the operational life of such large-scale networks. As IT operation environments house a large number of assets required by the business for daily operations, subject matter experts (SMEs) and chief information officers (CIOs) require a comprehensive view of the environment behavior. In most cases, a random view of a time series describing a system behavior would show outages that are not easily explained. CIOs typically ask their SMEs for information about assets outages which require the SME to investigate the root cause of the outage by examining related outages and analyze audit logs or other related data sources.

At present, SMEs use existing tools such as VCOPS and Log-Insight to investigate outliers and look separately at each time series set of data or aggregated log counts to find numerical anomalies, ignoring the textual content of the logs or the relation of the different components of the system. Such tools can provide information about a specific type of data (e.g., log events, numeric performance indicator, etc.), but the SME will usually need to go over the outputs and explore the information from each tool in order to get the entire picture.

Current analysis processes using such tools suffer from several challenges. First, they consume a lot of time as analyzing an outage involves collecting data from each one of the sources and correlating it with the relevant outliers found in the time series data. This makes the process slow and costly. Second, present systems require expert knowledge. Finding a root cause to an outage contained within massive amounts of log events is usually done by an expert who is familiar with the regular behavior of the system and can filter out irrelevant events based on his or her own knowledge. Third, present methods suffer from low accuracy. The manual root cause analysis process is complicated and prone to mistakes that leads to low accuracy. Fourth, present systems are limited by periodicity. They provide no real-time visibility to the system status and cannot detect anomalies and react quickly when an unexpected scenario occurs, such as running out of storage, encountering slow backup times, and so on.

What is needed, therefore, is a IT environment or network system analysis process that provides comprehensive context for network events and real-time insights about the status of assets within the environment so that proper decisions can be made to remedy particular issues and anomalies.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates a large-scale network system with devices that implement one or more embodiments of a significant events identifier process, under some embodiments.

FIG. 2 illustrates the main functional components and/or processes of the significant events identifier of FIG. 1, under some embodiments.

FIG. 3 illustrates the general schema of a recursive neural network (RNN) used by a log events analyzer, under some embodiments.

FIG. 4 illustrates an example labeled chart output by the significant events identifier method, under some embodiments.

FIG. 5 is a flowchart illustrating an overall method of identifying significant events for an outlier root cause investigation, under some embodiments.

FIG. 6 is a block diagram of a computer system used to execute one or more software components of a significant events identifier, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the described embodiments.

Some embodiments of the invention involve large-scale IT networks or distributed systems (also referred to as “environments”), such as a cloud based network system or very large-scale wide area network (WAN), or metropolitan area network (MAN). However, those skilled in the art will appreciate that embodiments are not so limited, and may include smaller-scale networks, such as LANs (local area networks). Thus, aspects of the one or more embodiments described herein may be implemented on one or more computers in any appropriate scale of network environment, and executing software instructions, and the computers may be networked in a client-server arrangement or similar distributed computer network.

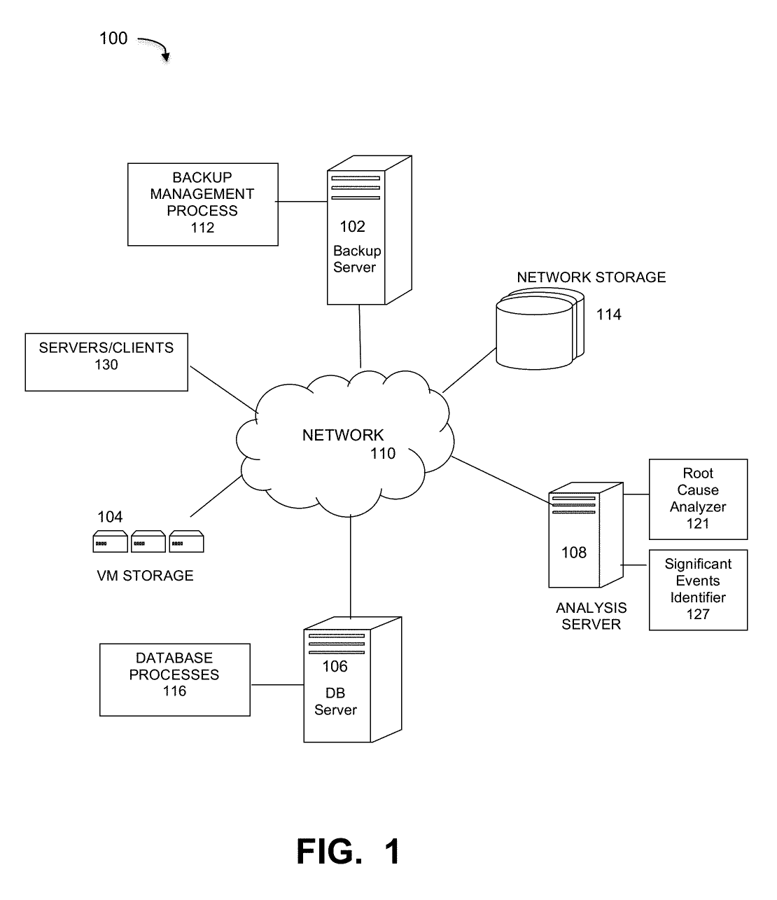

As stated above, large-scale networks having large numbers of interconnected devices (“resources” or “assets”) often exhibit unusual or abnormal behavior due to a variety of fault conditions or operating problems. Finding the significant events that can help determine the root cause of such behavior is often a time and labor-intensive process requiring the use of specialized personnel and/or sophisticated analysis tools. FIG. 1 is a diagram of a network implementing a significant events identifier for outlier root cause investigation, under some embodiments.

FIG. 1 illustrates an enterprise data protection system that implements data backup processes using storage protection devices, though embodiments are not so limited. For the example network environment 100 of FIG. 1, a backup server 102 executes a backup management process 112 that coordinates or manages the backup of data from one or more data sources, such as other servers/clients 130 to storage devices, such as network storage 114 and/or virtual storage devices 104. With regard to virtual storage 114, any number of virtual machines (VMs) or groups of VMs (e.g., organized into virtual centers) may be provided to serve as backup targets. The VMs or other network storage devices serve as target storage devices for data backed up from one or more data sources, which may have attached local storage or utilize networked accessed storage devices 114.

The network server computers are coupled directly or indirectly to the target VMs, and to the data sources through network 110, which is typically a cloud network (but may also be a LAN, WAN or other appropriate network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing platform. In an embodiment, system 100 may represent a multi-tenant network in which a server computer runs a single instance of a program serving multiple clients (tenants) in which the program is designed to virtually partition its data so that each client works with its own customized virtual application, with each VM representing virtual clients that may be supported by one or more servers within each VM, or other type of centralized network server.

The data generated or sourced by system 100 may be stored in any number of persistent storage locations and devices, such as local client or server storage. The storage devices represent protection storage devices that serve to protect the system data through the backup process. Thus, backup process 112 causes or facilitates the backup of this data to the storage devices of the network, such as network storage 114, which may at least be partially implemented through storage device arrays, such as RAID components. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays. The data sourced by the data source (e.g., DB server 106) may be any appropriate data, such as database data that is part of a database management system 116, and the data may reside on one or more hard drives for the database(s) in a variety of formats.

As stated above, the data generated or sourced by system 100 and transmitted over network 110 may be stored in any number of persistent storage locations and devices, such as local client storage, server storage, or other network storage. In a particular example embodiment, system 100 may represent a Data Domain Restorer (DDR)-based deduplication storage system, and storage server 102 may be implemented as a DDR Deduplication Storage server provided by EMC Corporation. However, other similar backup and storage systems are also possible.

Although embodiments are described and illustrated with respect to certain example implementations, platforms, and applications, it should be noted that embodiments are not so limited, and any appropriate network supporting or executing any application may utilize aspects of the root cause analysis process described herein. Furthermore, network environment 100 may be of any practical scale depending on the number of devices, components, interfaces, etc. as represented by the server/clients 130 and other elements of the network.

FIG. 1 generally represents an example of a large-scale IT operation environment that contains a large number of assets required by the business for daily operations. These assets are monitored by different response requirements, from every second to once a month or quarter, or more. Understanding unusual behavior of assets in the environment is crucial for the operation of the business, but it is not a trivial task, especially when there are numerous assets which are feeding each other or are connected in various ways. As stated above, different tools are available for analysts to investigate outliers in the system behavior, such as VCOPs, Splunk, Log-Insight, and so on. Present analysis methods require the analyst (SME) to review all of the outputs from each tool to get an entire picture of the network condition. Embodiments include automated tools or functional components/processes that identify significant events to find the root cause of outlier conditions using certain models to analyze event importance and thus identify significant events within a vast time line of events in the network.

In an embodiment, network system 100 includes an analysis server 108 that executes significant events identifier process 127 that gathers and analyzes time series data of the network and its devices to identify significant events among the vast number of events generated every period. It further provides a user interface to display the events in historical context so that SMEs and other personnel can assess actual network conditions and pursue appropriate remedial measures in the event of abnormal or problematic events. Embodiments of the significant event identifier 127 may be used with a root cause analyzer process 121. This process 121 may implement an automated procedure that finds the root cause of anomalies, unusual behavior or problems exhibited by any of the components in system 100. It uses a causal graph of the system acquired using domain experts or by using a semi-supervised tool. In an embodiment, the analyzer process 121 finds possible causes using a causal graph, and generates a prioritized list of possible causes to an observed anomaly. The result allows analysts to explore and verify the real cause of an anomaly in real or near real time. For the embodiment of FIG. 1, the significant events identifier 127 may be associated with, or included as part of the root cause analyzer 121 or it may be a separate component, as shown in FIG. 1.

The anomaly detector 121 and or significant events identifier 127 may be embodied as a hardware component provided as part of analysis server 108 as a programmable logic circuit, such an FPGA, ASIC, or other similar hardware module. Alternatively, it may be embodied as a program executed by processors and processing hardware of analysis server 108. It may also be embodied as firmware integrating aspects of both hardware and software (executable program) elements residing in or executed by processors and circuitry of analysis server 108. In yet a further embodiment, processes 121 and/or 127 may be partially or wholly executed by or integrated within one or more other servers of system 100. It may also be partially or wholly embodied as a server-side, client-side, or distributed (server-client) component or process within one or more processor-based elements of system 100.

Embodiments of significant identifier component 127 include a process and system to filter significant events using RNN and Markov Chains models to analyze the importance of each event of a time series of events. The process tags and shows the filtered events which overlays selected important events coming from all the different sources on top of any time series data for display to the user in the form of a comprehensive graph or report. The desired events are anomalies (in terms of textual content) or trend changes found on any of the data sources and displayed on a single chosen time-series.

Embodiments include a graphical user interface (GUI) that allows personnel to get a visual display of the outages augmented with the relevant events tagged on top of it. The augmented tagged events will serve as supporting evidence of any outage investigated. This visual display can be used to help plan for the future and take more inform decisions with regards to resource planning as well as support and maintenance hours. In addition, since all the analysis is done in real-time the system can notify personnel if an unexpected behavior was identified and point to potential root cause or causes for it.

The significant events analyzer builds on an anomaly detection process and adds certain features including: analyzing numeric and performance data to detect an anomaly, analyzing textual information from multiple sources (e.g., log data) in the time area of the anomaly to find related and informative logs leveraging state-of-the-art deep learning models such as Recurrent Neural Networks (RNN) and LSTM in addition to Markov Chains, and automatically overlaying the most significant actual logs/source information over the time series display. This process does not just display the anomaly or a numerical indicator of the anomaly, but rather the actual related log/source events. This feature provides a major advantage over previous methods as it provides proof, context, or supporting evidence of an event. This data analysis and presentation adds tools to help understand the logs or figure out what parts of the data source is relevant. It greatly enables an SME reading the logs or data sources to relate the logs to the events and identify valid issues and appropriate remedial measures.

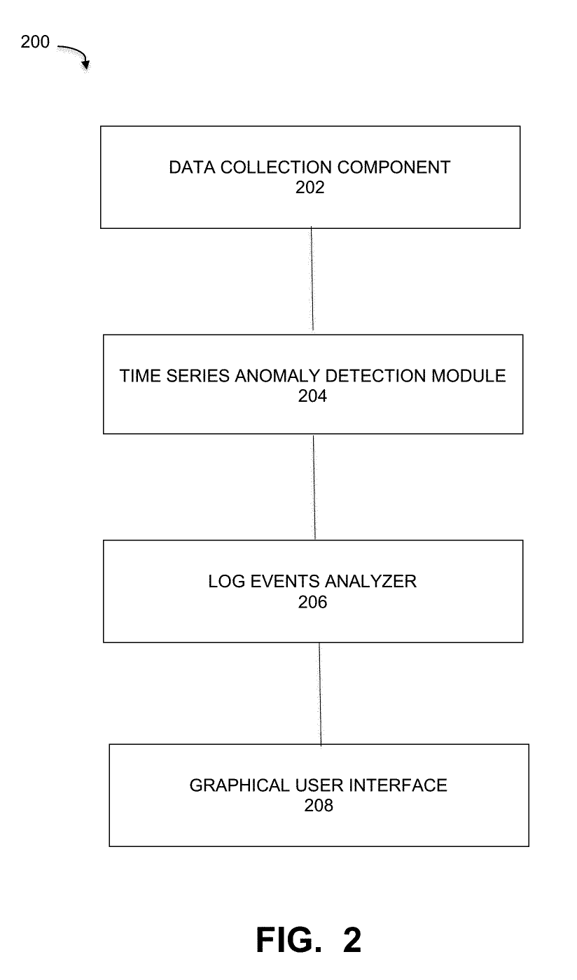

FIG. 2 illustrates the main functional components and/or processes of the significant events identifier 127 of FIG. 1, under some embodiments. As shown in diagram 200, the main components include a near real-time data collection component 202, a time series anomaly detection module 204 that is applied over the numeric performance data by the collection component 202 to identify outages of the environment, a log analyzer 206 that filters and maps outages to relevant events, and a user interface 208 that presents the performance of the system across time overlapped with important events tagged to it.

As shown in diagram 200, the data collection component 202 may implement an agent process that is deployed to collect data from the assets. The agents may be provided by the assets, such as data protection appliance (DPA) or eCDA agents, or they may be network agents that monitor transactions between the agents. Alternatively, data collection may be performed based on processes that are provided as part of the agents themselves. For example, storage and protection assets may be configured to send data regarding their status to manufacturers or other parties on a regular basis or on a defined frequency, such as every five minutes an appliance may send CPU, memory, daily capacity samples etc., to the companies that made them. Other appropriate data collection processes are also possible. The collected data is parsed and stored in centralized data store. The data should contain information about the performance and event logs.

As described above, the root cause analyzer 121 for an anomaly detector may be used with or as part of an Enterprise Copy Data Analytics (eCDA) program 119 as the decision support system, which is a cloud analytics platform that provides a global view into the effectiveness of data protection operations and infrastructure. This platform provides a global map view displaying current protection status for each site in a simple-to-understand and compare score. Enterprise CDA leverages historical data to identify anomalies and generate actionable insights to more efficiently optimize a protection infrastructure. Other decision support systems are also possible.

With respect to the time series anomaly detection module 204, there are several known ways to find anomalies in a time series. Anomaly detection for time series typically involves finding outlier data points relative to a standard (usual or normal) signal. There can be several types of anomalies and the primary types include additive outliers (spikes), temporal changes, and seasonal or level shifts. Anomaly detection processes typically work in one of two ways. First, they label each time point as an anomaly or non-anomaly; second, they forecast a signal for some point and test if the point value from the forecast by a margin defining it as an anomaly. In an embodiment, any anomaly detection method may be used including STL (seasonal-trend decomposition), classification and regression trees, ARIMA modeling, exponential smoothing, neural networks, and other similar methods.

Some anomaly detection methods employ smoothers of the time-series while others use forecasting methods. For detecting an outlier on the edge of a time series (the newest point), forecasting methods are generally better suited. In an embodiment, the anomaly detection process 204 conducts a competition between different forecasting models and chooses the one that performs the best on a test data set, i.e., the one that has the minimal error. The best model is used for forecasting, and the difference between the actual value and the predicted one is calculated and evaluated. If the residual is significantly larger when comparing to the residual population the process declares the event to be an anomaly. This method also detects unexpected changes in trend or seasonality, where seasonality refers to the periodic fluctuations that may be displayed by time series, such as backup operations increasing at midnight. The process can also be configured to assign weights for the anomalies based on the significance of the residual for a weighted calculation. When an outage is discovered, the detection module 204 triggers the log events analyzer module 206, which will find the potential causes in the events data.

With respect to the log events analyzer 206, given the output of the anomaly detection module 204, this module gets the timestamp of the outage and analyzes all the events around this timestamp from multiple sources. This helps to filter usual events and mark the importance of each event, which is the importance in terms of describing and explaining the outage cause. In order to determine which event is important and which is not, the method extracts the relevant features from the logs and counts the number of occurrences for each feature-value pair and their relative order. In an embodiment, the log events analyzer 206 uses a method that is based on LSTM/RNN (Long Short-Term Memory/Recurrent Neural Networks) and Markov Chains for log analysis. Both methods get as an input a series of log events, denoted (x₀, . . . , xₙ₋₁), and the output is the probability of event xₙ to happen. This enables an understanding of whether or not an event can be considered normal or not normal.

A Markov chain describes a sequence of possible events in which the probability of each event depends only on the state attained in the previous event. A Markov chain can be expressed as follows:

P(Xₙ=xₙ|Xₙ₋₁=xₙ₋₁,Xₙ₋₂=xₙ₋₂, . . . ,X₀=x₀)=P(Xₙ=xₙ|Xₙ₋₁=xₙ₋₁)

In an embodiment, the log events analyzer uses a Markov chain from order m, where m is the constant chosen for the analysis, and defines how many log events from the past that should be taken into account. The constant m can be a system or a user configured parameter. Using the constant value m, yields an expression of the Markov chain as follows:

$$P ( {X}_{n} = {x}_{n} \vert {X}_{n - 1} = {x}_{n - 1} , {X}_{n - 2} = {x}_{n - 2} , … , {X}_{0} = {x}_{0} ) = P ( {X}_{n} = {x}_{n} \vert {X}_{n - 1} = {x}_{n - 1} , {X}_{n - 2} = {x}_{n - 2} , … , {X}_{n - m} = {x}_{0 n - m} )$$

In the RNN approach, the process also learns patterns of sequences (rather than single events) in the log data to determine what should be the next event that the system will generate. RNNs can be considered as neural networks with memory to keep information of what has been processed so far. An RNN is generally created by applying the same set of weights recursively over a differentiable graph by traversing the graph in topological order. The LSTM units are the building blocks for the RNN and an RNN composed of LSTM units is referred to as an LSTM network. A common LSTM unit is composed of a cell, an input gate, an output gate and a forget gate. The cell is responsible for remembering values over arbitrary time intervals, thus providing the memory function. RNNs are very powerful dynamic systems for sequence tasks, and this characteristic is leveraged for the log analysis process by inserting the log events in their original order to predict the next event. Thus, in an embodiment, the log events analyzer receives log events in a specific fields in the log, for example the logID, in the original order, as follows:

x₀, . . . ,xₜ₋₂,xₜ₋₁,xₜ

The output of the analyzer 206 will then be the next event that the model predicts to happen, as expressed by

o₁, . . . ,oₜ₋₁,oₜ,oₜ₊₁

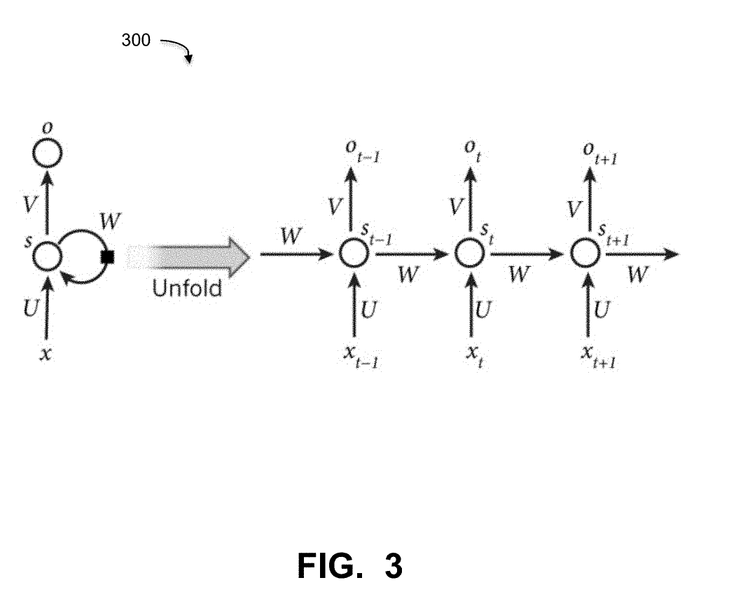

FIG. 3 illustrates the general schema of an RNN as used by a log events analyzer under some embodiments. In diagram 300 of FIG. 3, Sₜ=f(Uxₜ+Wsₜ₋₁) and y=g(Vsₜ). FIG. 3 illustrates one example of an RNN schema and embodiments are not so limited. Other possible schema may be used as appropriate.

In general, RNNs excel at capturing the order in which previous events were executed. This helps in the identification of anomalous processes, (e.g., a continued increase of power usage) which were hidden as normal events when analyzed separately. Using this output, the process 200 can learn the difference between the actual events and the predicted events. By further calculating the distances, it can determine if the sequence can be considered an anomaly. As used herein a distance is basically the probability of getting an event (event X) as an input. The RNN model can give as an output the distribution over all inputs, and the system can use these probabilities for calculating the distances.

Using the methods of RNN/LSTM and Markov chain, the log events analyzer has the ability to calculate a score for each log record that will determine how rare is a present event.

In an embodiment, the combination between the LSTM and Markov chain is done by assigning coefficient weights that are learned based on user feedback or configurations and using a simple machine learning model. In particular the user will feedback the score by a defined rating value, such as a score between 1 to 5. The process uses this feedback as labels to a supervised learning model that learns the weighted coefficients wᵣₙₙ and w_{mc}, for the following event score calculation:

Event score=LSTM Score*wᵣₙₙ+MC Score*w_{mc}

In an embodiment, the user scoring process is implemented through a user interface that receives certain input from the user in response to certain outputs. For example, the user will get an alert and can respond by providing a rating or score for the alert. The rating can be a numerical rating or similar given to the alert. The scoring is subjective to the user and allows the system to customize the model to particular users. All the alerts and their LSTM and MC scores are stored in the system together with the user feedback. The event score is basically the prediction of the user rating. In order to predict if the user sees the given alert as important, the process trains a classification model (such as a random forecast on the historical data described above) and it will learn from the user feedback what should be the score of the event.

The method assumes that an anomaly in the performance should be a result of an unusual event. Thus, it searches for rare events and configuration changes that are correlated with the timestamp of the outlier. This identifies the most informative events which can explain the outage.

Embodiments of component 127 include a process and system to filter significant events using RNN and Markov chains models to analyze the importance of events. The process tags and shows the filtered events which overlays selected important events coming from all the different sources on top of any time series data. The desired events will be anomalies (in terms of textual content) or trend changes found on any of the data sources and displayed on a single chosen time-series. As shown in FIG. 2, a user interface 208 presents to the user the time series charts with labels on top of it to provide an interactive chart that connects the outliers (in contrasting display such as color or pattern) to the events. The graph is interactive so that the user can click on the tag labels to access further information about the event itself, such as event description, data source and timestamp.

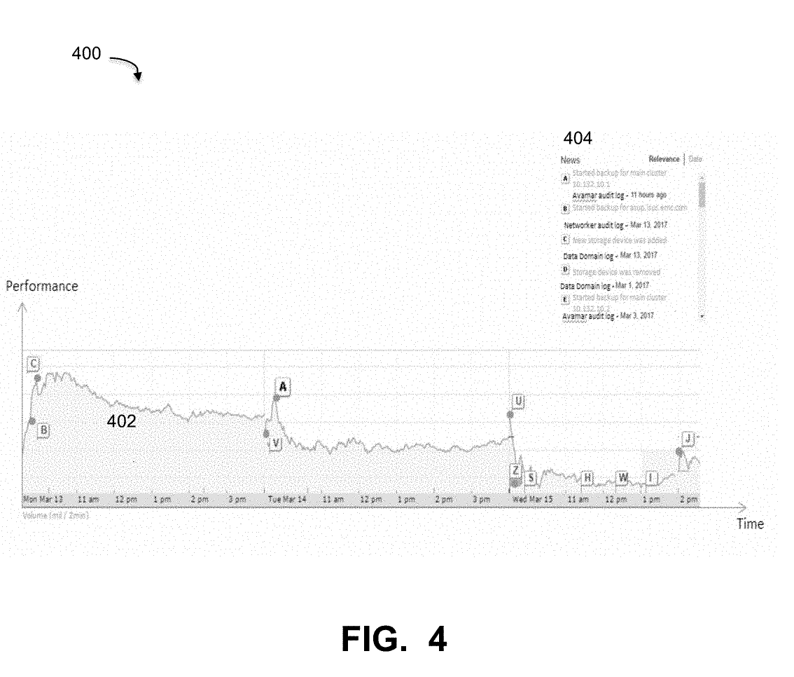

FIG. 4 illustrates an example labeled chart for the significant events identifier method, under some embodiments. The display 400 shown in the example of FIG. 4 comprises a graph 402 of network showing events as the performance of the network (devices and interfaces) along a timeline (e.g., hours in a day). The unit of performance can be any appropriate measurable metric, such as bandwidth, throughput, processor speed, and so on. The time-series performance metric generates a trace over time that is typically characterized by peaks and valleys, which themselves may be characterized as events. The graph 402 is tagged with an indexed label identifying each of the events and any detected anomalies in a contrasting visual manner. These are shown as indexed labels A through Z for display trace 402. the indexed label comprises an alphanumeric character superimposed proximate the events and anomaly, and wherein the chart comprises an interactive chart wherein each indexed label provides an interface providing to information about each event, the information including description, data source, and time of event.

The display 400 also includes an event description display area 404 that lists the information for each relevant event. The example of FIG. 4 illustrates an application of the significant events identifier in the context of a backup application in which a time series of a storage utilization is augmented by anomalies of backup jobs events. The display area 404 lists the events such as “Avamar backed up a new machine”, “machine X backed up unusual amount of data”, or from configuration events such as “another 1 TB storage device installed or removed from Data Domain X”. These identified events suggest a possible explanation for the behavior of the storage utilization. The graph display area 402 shows the events laid over the time-series in their respective time with a short description of the event keyed by the event identifier to description 404.

The illustrated display output of FIG. 4 is intended to be an example only, and embodiments are not so limited. Any appropriate graph format and time-dependent parameter (y-axis) may be used depending on the network environment and application.

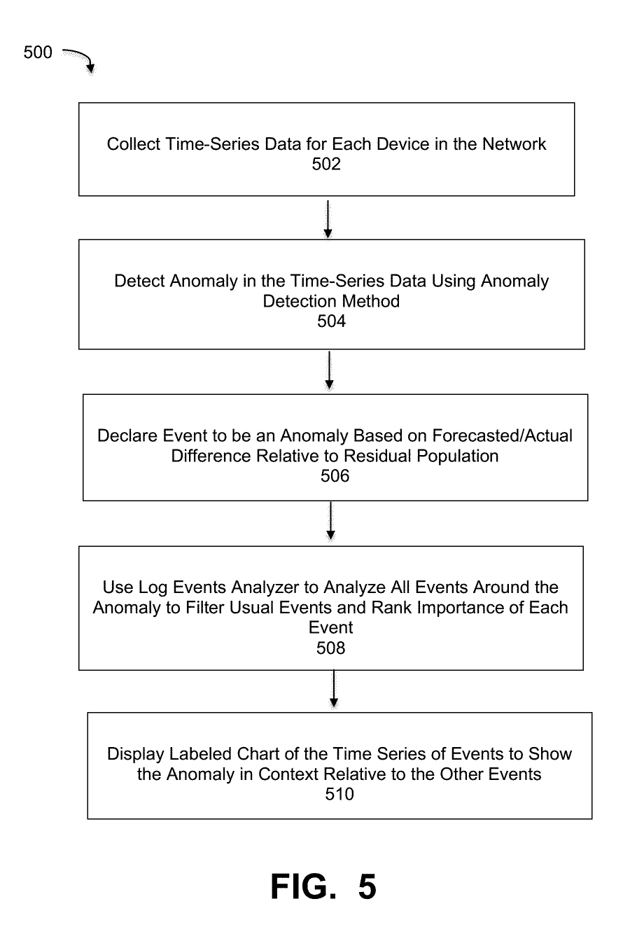

FIG. 5 is a flowchart illustrating an overall method of identifying significant events for an outlier root cause investigation, under some embodiments. Process 500 starts by collecting time series data for events for each device of the network, 502. A time series anomaly detector is then used to detect an anomaly that comprises an outlier on an edge of the time series data by comparing a predicted value of the event to an actual value of the event using a selected forecasting model, or any other appropriate anomaly detection method, 504. The process declares an event to be an anomaly at a particular time if a difference between the predicted value and actual value exceed a defined threshold based on residual values for other devices of the network, 506. A log events analyzer is then used to analyze all events for all devices of the network within a defined time proximity of the particular time of the anomaly to filter usual events and rank each event relative to the anomaly, 508. A labeled chart of the time series is then displayed to the user through a GUI to show the anomaly in a graphical context relative to all the other temporally proximate events, 510.

### Detecting Anomalies

As shown and described above, the root cause analyzer 121 is used to find the root cause of detected anomalies that are tied to certain network events. Anomaly detection for time series typically involves finding outlier data points relative to a standard (usual or normal) signal. There can be several types of anomalies and the primary types include additive outliers (spikes), temporal changes, and seasonal or level shifts. Anomaly detection processes typically work in one of two ways. First, they label each time point as an anomaly or non-anomaly; second, they forecast a signal for some point and test if the point value from the forecast by a margin defining it as an anomaly. In an embodiment, any anomaly detection method may be used including STL (seasonal-trend decomposition), classification and regression trees, ARIMA modeling, exponential smoothing, neural networks, and other similar methods.

In an embodiment, anomaly detection can use a causal graph encompasses time-series data for each of the components, such as temporal log data from transactions for each component. Embodiments use one of several known ways to find anomalies in a time series. For example, one method uses smoothers of the time-series, while others use forecasting methods. For detecting an outlier on the edge of a time series (the newest point), forecasting methods are generally more suitable. In an embodiment, the process conducts a competition between different forecasting models and chooses the one that performs the best on a test data set, i.e., the one that has the minimal error. The best model is used for forecasting and the difference between the actual value and the predicted one is calculated and evaluated. If the residual is significantly larger when comparing to the residual population, it is declared as an anomaly. The residual population essentially defines a threshold value against which an actual residual can be compared to allow the process to declare the outlier to be an anomaly. This method will thus detect unexpected changes in trend or seasonality, where seasonality refers to the periodic fluctuations that may be displayed by time series, such as backup operations increasing at midnight. The process can also be configured to assign weights for the anomalies based on the significance of the residual for a weighted calculation.

### System Implementation

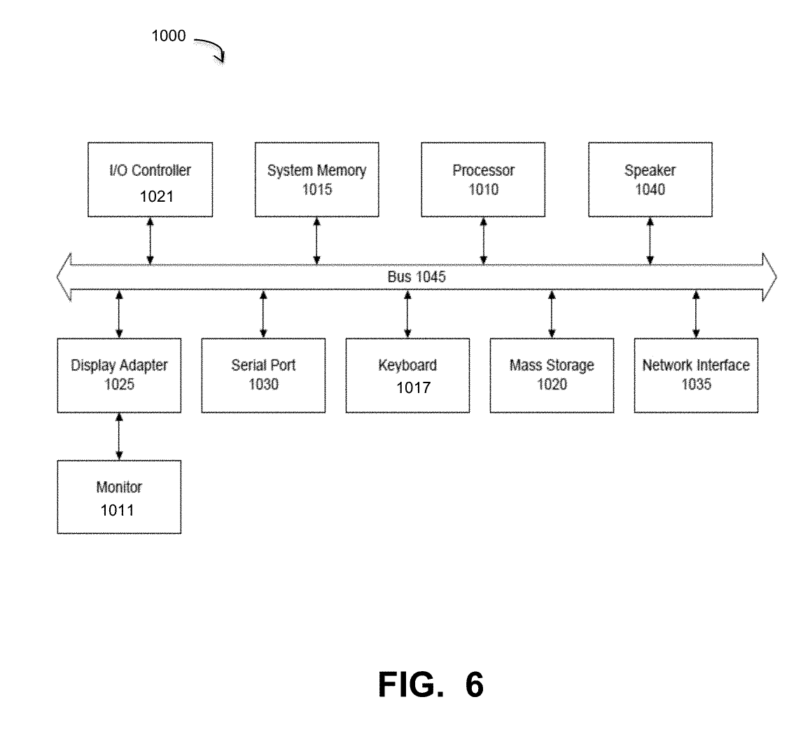

As described above, in an embodiment, system 100 includes a significant events identifier 127 that may be implemented as a computer implemented software process, or as a hardware component, or both. As such, it may be an executable module executed by the one or more computers in the network, or it may be embodied as a hardware component or circuit provided in the system. The network environment of FIG. 1 may comprise any number of individual client-server networks coupled over the Internet or similar large-scale network or portion thereof. Each node in the network(s) comprises a computing device capable of executing software code to perform the processing steps described herein. FIG. 6 is a block diagram of a computer system used to execute one or more software components of a significant events identifier, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

The processor 1010 is generally configured to execute program modules that comprise all or some of the software programs that may include processes described herein when they are embodied as software. Other components of system 1000, such as may be incorporated as part of processor 1010 or accessed via interfaces 1030 or 1035 may include programmable elements or circuits (ASICS, programmable arrays, etc.) that are wired or configured to embody the functions provided by the components and processes described herein.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 shown in FIG. 6 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac OS X, IRIX32, or IRIX64. Other operating systems may be used. Microsoft Windows is a trademark of Microsoft Corporation.

Although certain embodiments have been described and illustrated with respect to certain example network topographies and node names and configurations, it should be understood that embodiments are not so limited, and any practical network topography is possible, and node names and configurations may be used. Likewise, certain specific programming syntax and data structures are provided herein. Such examples are intended to be for illustration only, and embodiments are not so limited. Any appropriate alternative language or programming convention may be used by those of ordinary skill in the art to achieve the functionality described.

Embodiments may be applied to data, storage, industrial networks, and the like, in any scale of physical, virtual or hybrid physical/virtual network, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of identifying significant events for finding a root cause of an anomaly in a network having a server computer, comprising:
collecting time series data for events for each device of the network;
detecting, in a detector component of the server, an anomaly in the time series data comprising an outlier on an edge of the time series data by comparing a predicted value of the event to an actual value of the event using a selected forecasting model;
declaring the event to be an anomaly at a particular time if a difference between the predicted value and actual value exceed a defined threshold based on residual values for other devices of the network;
analyzing, in an analyzer component of the server, all events for all devices of the network within a defined time proximity of the particular time of the anomaly to filter usual events and rank each event relative to the anomaly; and
displaying to a user, through a graphical user interface of a client computer of the network, a labeled chart of the time series data showing the anomaly in a graphical context relative to all the events.

2. The method of claim 1 wherein the time series data comprises near real-time data as transaction log information written to a central data store, and wherein the events comprise performance metrics of the device and network transactions to and from the device.

3. The method of claim 2 wherein the analyzing further comprises:
extracting relevant features from the log information;
assigning a value to each feature of the relevant features; and
counting a number of occurrences for each feature value pair in their relative order.

4. The method of claim 3 wherein the analyzing comprises a Recurrent Neural Network (RNN) process and Markov chain process taking as input a time series of log events and providing as output a probability of a next event to occur or not occur to enable analysis of the next event as normal or not normal.

5. The method of claim 4 further comprising:
determining, for each of the RNN process and LSTM process, distances between actual events and predicted events; and
calculating a respective score for each log event of the time series of log events based on the distances to help determine a rarity of the next event.

6. The method of claim 5 further comprising combining the RNN process and the Markov chain process by assigning respective coefficient weights to each of the distances for the RNN process and the Markov chain process.

7. The method of claim 6 further comprising receiving user feedback of the respective score for each log event, wherein the coefficient weights are determined based on the user feedback using a simple machine learning model, and wherein the score comprises a numeric ranking within a defined range.

8. The method of claim 7 further comprising calculating an event score for each event by summing a weighted RNN score for an event with a weighted Markov chain score for the event.

9. The method of claim 8 further comprising labeling the chart with an indexed label identifying each of the events and the anomaly in a contrasting visual manner.

10. The method of claim 9 wherein the indexed label comprises an alphanumeric character superimposed proximate the events and anomaly, and wherein the chart comprises an interactive chart wherein each indexed label provides an interface providing to information about each event, the information including description, data source, and time of event.

11. The method of claim 4 wherein the RNN comprises a long short-term memory (LSTM) RNN network.

12. The method of claim 2 wherein the log information is collected by one of: an agent process embedded in each device of the network, or automatic status transmitting mechanisms native to each device.

13. A system of identifying significant events for finding a root cause of an anomaly in a network having a server computer, comprising:
a data collector collecting time series data for events for each device of the network;
a detector component of the server detecting an anomaly in the time series data comprising an outlier on an edge of the time series data by comparing a predicted value of the event to an actual value of the event using a selected forecasting model, and declaring the event to be an anomaly at a particular time if a difference between the predicted value and actual value exceed a defined threshold based on residual values for other devices of the network;
an analyzer component of the server analyzing all events for all devices of the network within a defined time proximity of the particular time of the anomaly to filter usual events and rank each event relative to the anomaly; and
a graphical user interface functionally coupled to a client computer of the network displaying a labeled chart of the time series data showing the anomaly in a graphical context relative to all the events.

14. The system of claim 13 wherein the time series data comprises near real-time data as transaction log information written to a central data store, and wherein the events comprise performance metrics of the device and network transactions to and from the device.

15. The system of claim 14 wherein the analyzer comprises a Recurrent Neural Network (RNN) process and Markov chain process taking as input a time series of log events and providing as output a probability of a next event to occur or not occur to enable analysis of the next event as normal or not normal, and further extracts relevant features from the log information, assigns a value to each feature of the relevant features, and counts a number of occurrences for each feature value pair in their relative order.

16. The system of claim 15 wherein the analyzer further determines, for each of the RNN process and LSTM process, distances between actual events and predicted events, and calculates a respective score for each log event of the time series of log events based on the distances to help determine a rarity of the next event.

17. The system of claim 16 wherein the analyzer combines the RNN process and the Markov chain process by assigning respective coefficient weights to each of the distances for the RNN process and the Markov chain process, and receives user feedback of the respective score for each log event, wherein the coefficient weights are determined based on the user feedback using a simple machine learning model, and wherein the score comprises a numeric ranking within a defined range, and calculates an event score for each event by summing a weighted RNN score for an event with a weighted Markov chain score for the event.

18. The system of claim 17 wherein the chart is labeled with an indexed label identifying each of the events and the anomaly in a contrasting visual manner, the indexed label comprising an alphanumeric character superimposed proximate the events and anomaly, and wherein the chart comprises an interactive chart wherein each indexed label provides an interface providing to information about each event, the information including description, data source, and time of event.

19. The system of claim 18 wherein the RNN comprises a long short-term memory (LSTM) RNN network, and wherein the data collector comprises one of an agent process embedded in each device of the network, or automatic status transmitting mechanisms native to each device.

20. A computer program product, comprising a non-transitory computer-readable medium having a computer-readable program code embodied therein, the computer-readable program code adapted to be executed by one or more processors to perform a method of identifying significant events for finding a root cause of an anomaly in a network having a server computer, the method comprising:
collecting time series data for events for each device of the network;
detecting, in a detector component of the server, an anomaly in the time series data comprising an outlier on an edge of the time series data by comparing a predicted value of the event to an actual value of the event using a selected forecasting model;
declaring the event to be an anomaly at a particular time if a difference between the predicted value and actual value exceed a defined threshold based on residual values for other devices of the network;
analyzing, in an analyzer component of the server, all events for all devices of the network within a defined time proximity of the particular time of the anomaly to filter usual events and rank each event relative to the anomaly; and
displaying to a user, through a graphical user interface of a client computer of the network, a labeled chart of the time series data showing the anomaly in a graphical context relative to all the events.
